(19) United States
(12) Patent Application Publication
(10) Pub. No.: US 2011/0262783 A1
(43) Pub. Date: Oct. 27, 2011

(54) Battery Cell with Center Pin Comprised of an Intumescent Material

(75) Inventor: Vineet Haresh Mehta, San Francisco, CA (US)

(73) Assignee: TESLA MOTORS, INC., Palo Alto, CA (US)

(21) Appl. No.: 13/033,636

(22) Filed: Feb. 24, 2011

Related U.S. Application Data
(60) Provisional application No. 61/343,319, filed on Apr. 27, 2010.

(51) Int. Cl. H01M 10/50

(52) U.S. Cl. 429/62

(57) ABSTRACT

A center pin for a battery cell that is designed to improve the thermal behavior of a cell during a thermal runaway event is provided in which the center pin is comprised, at least in part, of an intumescent material. The intumescent material may be used to fill a void within the center pin, or to cover an outer surface of the center pin. When the intumescent material covers the center pin, a secondary non-intumescent material may surround the intumescent material, for example in the form of a sleeve, thereby minimizing or preventing chemical reactions from occurring between the intumescent material and the materials comprising the electrode assembly.

### CROSS-REFERENCE TO RELATED APPLICATION

The present application claims benefit to the filing date of U.S. Provisional Patent Application Ser. No. 61/343,319, filed Apr. 27, 2010, the disclosure of which is incorporated herein by reference for any and all purposes.

### FIELD OF THE INVENTION

The present invention relates generally to battery cells and, more particularly, to a method and apparatus for improving the performance of a cell during thermal runaway.

### BACKGROUND OF THE INVENTION

Batteries can be broadly classified into primary and secondary batteries. Primary batteries, also referred to as disposable batteries, are intended to be used until depleted, after which they are simply replaced with one or more new batteries. Secondary batteries, more commonly referred to as rechargeable batteries, are capable of being repeatedly recharged and reused, therefore offering economic, environmental and ease-of-use benefits compared to a disposable battery.

Although rechargeable batteries offer a number of advantages over disposable batteries, this type of battery is not without its drawbacks. In general, most of the disadvantages associated with rechargeable batteries are due to the battery chemistries employed, as these chemistries tend to be less stable than those used in primary cells. Due to these relatively unstable chemistries, secondary cells often require special handling during fabrication. Additionally, secondary cells such as lithium-ion cells tend to be more prone to thermal runaway than primary cells, thermal runaway occurring when the internal reaction rate increases to the point that more heat is being generated than can be withdrawn, leading to a further increase in both reaction rate and heat generation. Eventually the amount of generated heat is great enough to lead to the combustion of the battery as well as materials in proximity to the battery. Thermal runaway may be initiated by a short circuit within the cell, improper cell use, physical abuse, manufacturing defects, or exposure of the cell to extreme external temperatures.

Thermal runaway is of major concern since a single incident can lead to significant property damage and, in some circumstances, bodily harm or loss of life. When a battery undergoes thermal runaway, it typically emits a large quantity of smoke, jets of flaming liquid electrolyte, and sufficient heat to lead to the combustion and destruction of materials in close proximity to the cell. If the cell undergoing thermal runaway is surrounded by one or more additional cells as is typical in a battery pack, then a single thermal runaway event can quickly lead to the thermal runaway of multiple cells which, in turn, can lead to much more extensive collateral damage. Regardless of whether a single cell or multiple cells are undergoing this phenomenon, if the initial fire is not extinguished immediately, subsequent fires may be caused that dramatically expand the degree of property damage. For example, the thermal runaway of a battery within an unattended laptop will likely result in not only the destruction of the laptop, but also at least partial destruction of its surroundings, e.g., home, office, car, laboratory, etc. If the laptop is on-board an aircraft, for example within the cargo hold or a luggage compartment, the ensuing smoke and fire may lead to an emergency landing or, under more dire conditions, a crash landing. Similarly, the thermal runaway of one or more batteries within the battery pack of a hybrid or electric vehicle may destroy not only the car, but may lead to a car wreck if the car is being driven, or the destruction of its surroundings if the car is parked.

One approach to overcoming this problem is by reducing the risk of thermal runaway. For example, to prevent batteries from being shorted out during storage and/or handling, precautions can be taken to ensure that batteries are properly stored, for example by insulating the battery terminals and using specifically designed battery storage containers. Another approach to overcoming the thermal runaway problem is to develop new cell chemistries and/or modify existing cell chemistries. For example, research is currently underway to develop composite cathodes that are more tolerant of high charging potentials. Research is also underway to develop electrolyte additives that form more stable passivation layers on the electrodes. Although this research may lead to improved cell chemistries and cell designs, currently this research is only expected to reduce, not eliminate, the possibility of thermal runaway.

FIG. 1 is a simplified cross-sectional view of a conventional battery 100, for example a lithium ion battery utilizing the 18650 form-factor. Battery 100 includes a cylindrical case 101, an electrode assembly 103, and a cap assembly 105. Case 101 is typically made of a metal, such as nickel-plated steel, that has been selected such that it will not react with the battery materials, e.g., the electrolyte, electrode assembly, etc. Typically cell casing 101 is fabricated in such a way that the bottom surface 107 is integrated into the case, resulting in a seamless lower cell casing. The open end of cell case 101 is sealed by cap assembly 105, assembly 105 including a battery terminal 109, e.g., the positive terminal, and an insulator 111, insulator 111 preventing terminal 109 from making electrical contact with case 101. As shown, a typical cap assembly may also include an internal positive temperature coefficient (PTC) current limiting device, a current interrupt device (CID), and a venting mechanism, the venting mechanism designed to rupture at high pressures and provide a pathway for cell contents to escape. Additionally, cap assembly 105 may contain other seals and elements depending upon the selected design/configuration.

Electrode assembly 103 is comprised of an anode sheet, a cathode sheet and an interposed separator, wound around a center pin 113 to form a ‘jellyroll’. Typically center pin 113 is hollow, i.e., it includes a void 114 running its entire length, thus providing a path for gases formed during an over-pressure event to escape the cell via the vent contained within electrode cap assembly 105. An anode electrode tab 115 connects the anode electrode of the wound electrode assembly to the negative terminal while a cathode tab 117 connects the cathode electrode of the wound electrode assembly to the positive terminal. In the illustrated embodiment, the negative terminal is case 101 and the positive terminal is terminal 109. In most configurations, battery 100 also includes a pair of insulators 119/121. Case 101 includes a crimped portion 123 that is designed to help hold the internal elements, e.g., seals, electrode assembly, etc., in place.

In a conventional cell, such as the cell shown in FIG. 1, a variety of different abusive operating/charging conditions and/or manufacturing defects may cause the cell to begin generating excess internal heat. If the amount of internally generated heat is greater than that which can be effectively withdrawn, the cell may eventually enter into thermal runaway. During a cell abuse situation, it is common for localized hot spots 125 to form which, in turn, heat and weaken adjacent cell wall areas 127 of casing wall 101. At the same time as area 127 is being heated, potentially approaching its melting point, the adjacent area of electrode assembly 103 is deforming and expanding. Given the rigidity of center pin 113, the electrode assembly within this region is forced to expand in an outward direction towards weakened area 127 of the cell casing. As a result, if the cell abuse situation is not quickly abated, the cell may rupture in region 127. Once ruptured, the elevated internal cell pressure will cause additional hot gas to be directed to this location, further compromising the cell at this and adjoining locations and potentially heating adjacent cells to a sufficient temperature to cause them to enter into thermal runaway. Accordingly, it will be appreciated that the rupturing of the wall of one cell can initiate a cascading thermal runaway reaction that can spread throughout the battery pack.

To combat the effects of thermal runaway, and as previously noted, a conventional cell will typically include a venting element within the cap assembly 105 as shown. The purpose of the venting element is to release, in a somewhat controlled fashion, the gas generated during the thermal runaway event, thereby preventing the internal gas pressure of the cell from exceeding its predetermined operating range. While the venting element of a cell may help to control the cell's internal pressure, it may not prevent the rupturing of the cell and the propagation of an initial thermal runaway event.

Accordingly, what is needed is a means for controlling the occurrence of, and the effects of, thermal runaway. The present invention provides means for controlling the thermal energy generated during a thermal event, thereby minimizing the risks associated with a thermal event.

### SUMMARY OF THE INVENTION

The present invention provides a center pin for a battery cell that is designed to improve the thermal behavior of a cell during a thermal runaway event, where the center pin is comprised, at least in part, of an intumescent material. The intumescent material may be used to fill a void within the center pin, or to cover an outer surface of the center pin. When the intumescent material covers the center pin, a secondary non-intumescent material may surround the intumescent material, for example in the form of a sleeve, thereby minimizing or preventing chemical reactions from occurring between the intumescent material and the materials comprising the electrode assembly.

In one aspect of the invention, a battery assembly is provided that is comprised of a cell case, an electrode assembly contained within the cell case, and a center pin, where the electrode assembly is wrapped around the center pin and the center pin is comprised of an intumescent material (e.g., a graphite-based intumescent material, a thermoplastic elastomer, a ceramic-based intumescent material, a vermiculite/mineral fiber based intumescent material, an ammonium polyphosphate based intumescent material, etc.). The intumescent material may have an activation temperature in the range of 75° C. to 150° C.; in the range of 100° C. to 200° C.; or in the range of 200° C. to 300° C.; or within a different temperature range. The intumescent material may exhibit a volume expansion upon reaching the material's activation temperature of less than 20×; of less than 10×; of less than 5×; or of less than 2×. The center pin may be hollow, for example cylindrically shaped, where the intumescent material fills the void and where the hollow center pin may be formed of a metal, a plastic, or a ceramic. The center pin may include a central member, either a hollow central member or a solid central member, where the intumescent material covers the central member and where the central member may be formed of a metal, a plastic, or a ceramic. The center pin may include a central member, either a hollow central member or a solid central member, where the intumescent material covers the central member and where a layer of non-intumescent material covers the intumescent material.

A further understanding of the nature and advantages of the present invention may be realized by reference to the remaining portions of the specification and the drawings.

### BRIEF DESCRIPTION OF THE DRAWINGS

FIG. 1 is a simplified cross-sectional illustration of a cell utilizing the 18650 form-factor in accordance with the prior art;

FIG. 2 is a cross-sectional view of a cylindrical cell utilizing a center pin in which a central void within the pin is filled with an intumescent material;

FIG. 3 is a cross-sectional view of a cylindrical cell utilizing a hollow center pin that is covered with an intumescent material;

FIG. 4 is a cross-sectional view of a cylindrical cell utilizing a solid center pin that is covered with an intumescent material;

FIG. 5 illustrates a modification of the cell shown in FIG. 3 in which the layer of intumescent material is covered with a layer of a non-intumescent material; and

FIG. 6 illustrates a modification of the cell shown in FIG. 4 in which the layer of intumescent material is covered with a layer of a non-intumescent material.

### DESCRIPTION OF THE SPECIFIC EMBODIMENTS

In the following text, the terms “battery”, “cell”, and “battery cell” may be used interchangeably and may refer to any of a variety of different cell types, chemistries and configurations including, but not limited to, lithium ion (e.g., lithium iron phosphate, lithium cobalt oxide, other lithium metal oxides, etc.), lithium ion polymer, nickel metal hydride, nickel cadmium, nickel hydrogen, nickel zinc, silver zinc, or other battery type/configuration. The terms “center pin” and “center mandrel” may be used interchangeably herein and refer to a central element within a cell about which the electrodes are wound. It should be understood that identical element symbols used on multiple figures refer to the same component, or components of equal functionality. Additionally, the accompanying figures are only meant to illustrate, not limit, the scope of the invention and should not be considered to be to scale.

In a conventional cell, the rigidity of the center pin simplifies the fabrication of the electrode assembly and prevents electrode assembly deformation during normal charging and discharging operation. As excessive deformation of the electrode jellyroll may lead to electrode delamination and/or electrode shorting, its prevention is critical to the long-term health of the cell.

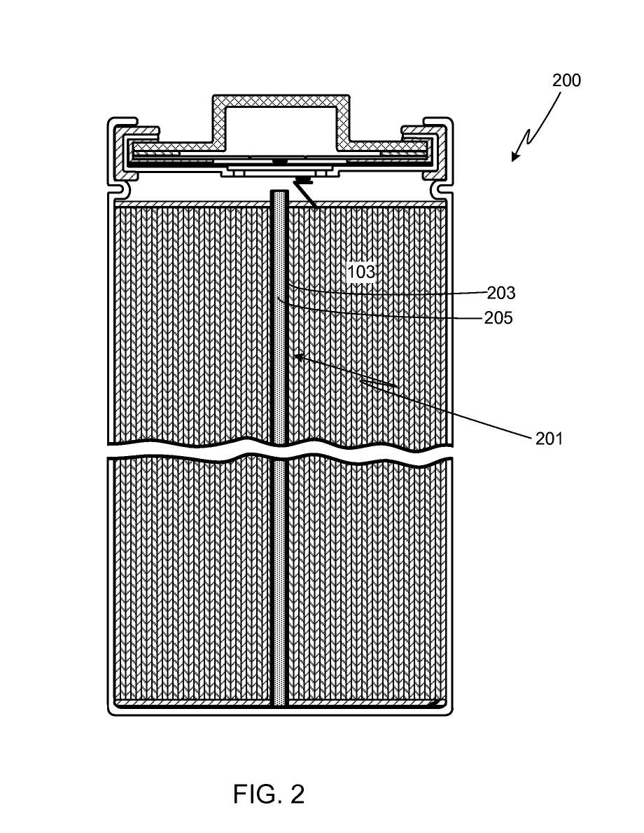

In accordance with the invention, and as illustrated in FIG. 2-6, the center pin of the electrode assembly of a battery includes an intumescent material, either disposed within the center of the pin or used as a layer of the pin. Even though the disclosed center pin includes an intumescent material, the construction of the disclosed center pin insures that it remains rigid as long as the temperature of the cell is within the desired cell operating range. Therefore during the manufacturing process as well as during normal cell operation, the disclosed center pin operates in the same manner and performs the same functions as a conventional center pin. However, during abnormal operation of the battery, i.e., during a cell abuse situation (e.g., cell overcharging, internal short, etc.) during which excess thermal energy is generated, the intumescent material absorbs the excess heat via an endothermal chemical reaction. By absorbing the excess heat, the thermal runaway event may be controlled, thereby potentially preventing the spread of the event to neighboring cells.

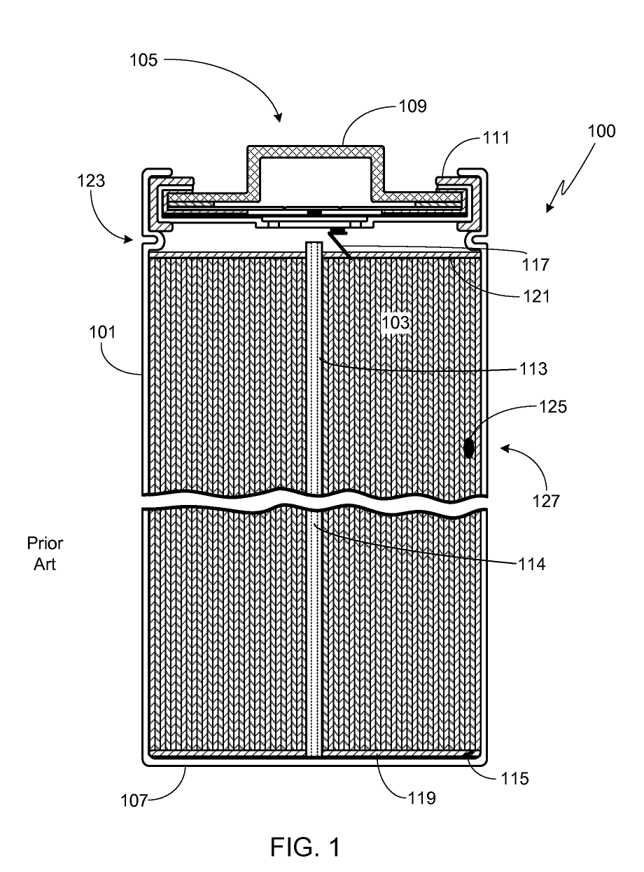

Cell 200, shown in FIG. 2, is of a similar design and construction to the conventional cell shown in FIG. 1, except for the fabrication of the center pin. In this embodiment, and assuming a cylindrical cell such as an 18650 form-factor cell, center pin 201 is in the form of a hollow cylinder 203. The central void that runs longitudinally throughout cylinder 203 is filled with intumescent material 205.

In cell 200, any of a variety of materials may be used in the fabrication of hollow cylindrical member 203. Typically the hollow cylindrical member 203 of center pin 201 is comprised of a metal that is chemically resistant to the materials used within the battery, for example the electrode assembly 103 and the electrolyte contained therein. Alternately, hollow cylindrical pin 203 may be comprised of a non-metallic material, such as a plastic (e.g., polycarbonate, PMMA, etc.), ceramic, or other material.

While cell 200 does not require the use of a particular intumescent material or a particular class of intumescent materials, the inventor has found that it is preferable to fill the void within pin 201 with an intumescent material 205 that exhibits minimal expansion upon reaching its start expansion temperature (i.e., SET) temperature. This type of intumescent material is preferred since the primary purpose of intumescent material 205 is to absorb the thermal energy generated during a thermal event, thereby helping to prevent cell ruptures and the spread of the thermal event to neighboring cells. Accordingly, in at least one embodiment, upon reaching the intumescent material's activation temperature, the selected intumescent material 205 exhibits volume expansion of less than 20×, preferably less than 10×, more preferably less than 5×, and still more preferably less than 2×. Exemplary intumescent materials include, but are not limited to, graphite-based intumescent materials, thermoplastic elastomers, ceramic-based intumescent materials, vermiculite/mineral fiber based intumescent materials, and ammonium polyphosphate based intumescent materials. The intumescent material may have an activation temperature (i.e., SET temperature) in the range of 75° C. to 150° C.; alternately, in the range of 100° C. to 200° C.; alternately, in the range of 200° C. to 300° C.

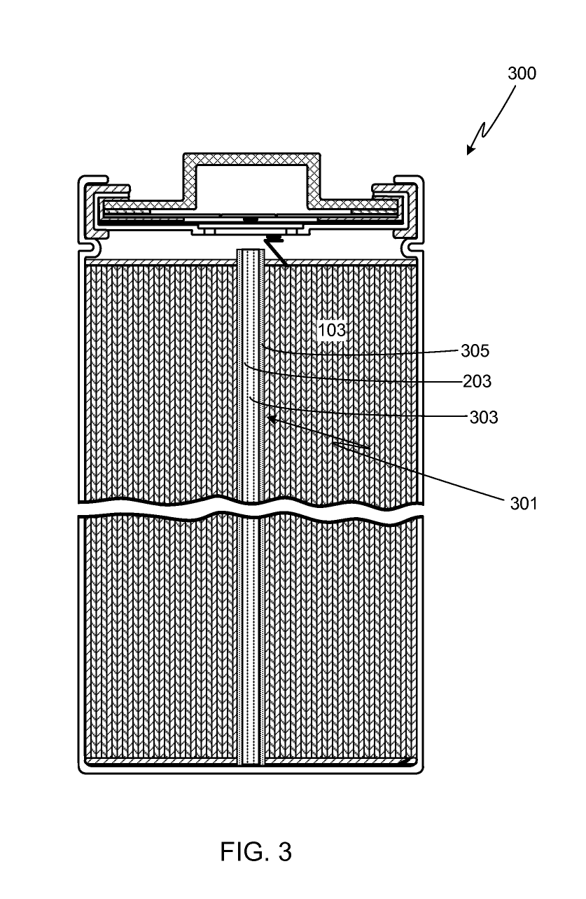

In cell 300, shown in FIG. 3, center pin 301 includes a hollow cylindrical member 203. As in the prior embodiment, hollow cylindrical member 203 may be fabricated from a metal or a non-metal such as a plastic, ceramic or other material. In this embodiment, however, void 303 that runs longitudinally throughout the pin is not filled with an intumescent material. Instead, void 303 remains open and unfilled, as in many conventional cells. The outer surface of center pin 301 is covered with a layer 305 of an intumescent material. As in cell 200, the primary purpose of intumescent material layer 305 is to absorb the excess thermal energy that is generated during a thermal event. Accordingly, the intumescent material selected for layer 305 exhibits volume expansion of less than 20×, preferably less than 10×, more preferably less than 5×, and still more preferably less than 2×upon reaching its activation temperature. Exemplary intumescent materials include, but are not limited to, graphite-based intumescent materials, thermoplastic elastomers, ceramic-based intumescent materials, vermiculite/mineral fiber based intumescent materials, and ammonium polyphosphate based intumescent materials. The intumescent material may have an activation temperature in the range of 75° C. to 150° C.; alternately, in the range of 100° C. to 200° C.; alternately, in the range of 200° C. to 300° C.

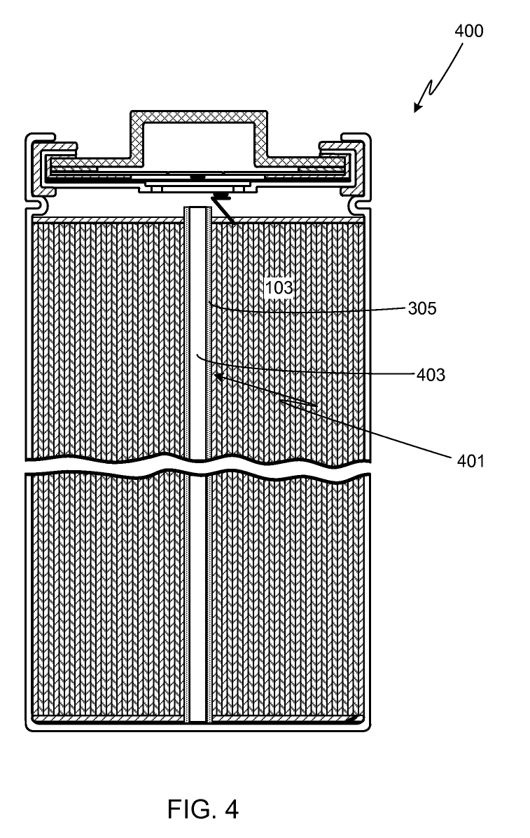

The embodiment shown in FIG. 4 includes a slight modification from the previous embodiment. As shown, the central cylindrical member 403 of center pin 401 is solid and does not include a central void. Cylindrical member 403 of cell 400 may be fabricated from a metal or a non-metal such as a plastic, ceramic or other material. The selection, and functionality, of intumescent layer 305 remains unchanged from that of cell 300.

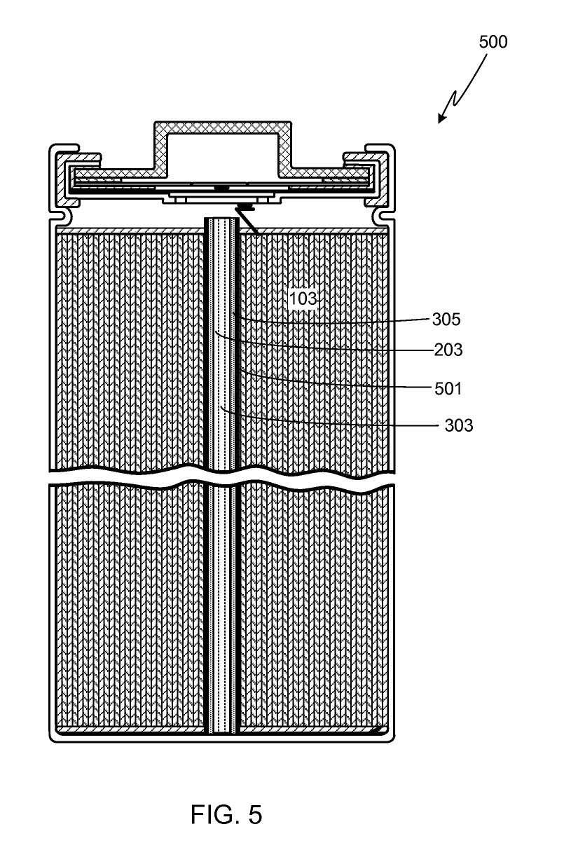

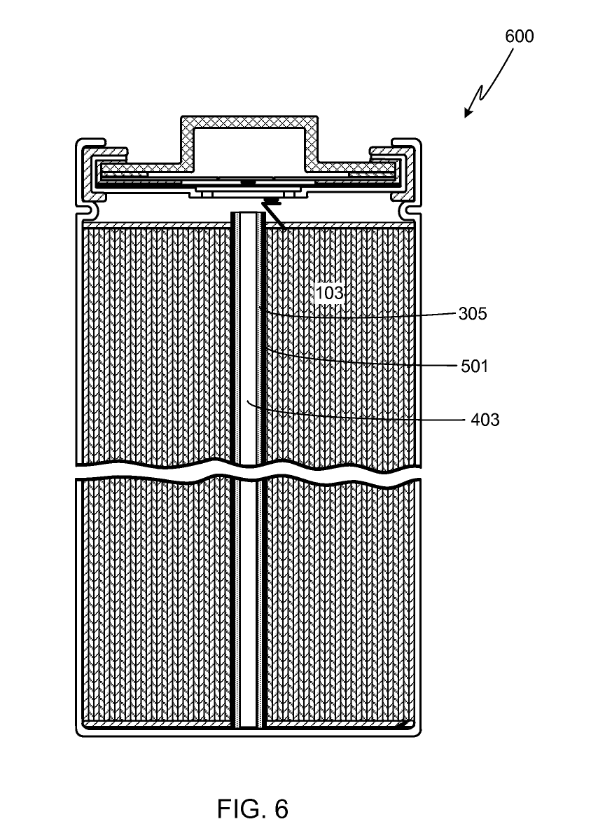

Cell 500 of FIG. 5 is similar to the embodiment shown in FIG. 3, except for the inclusion of an additional layer 501 that surrounds intumescent layer 305, layer 501 being fabricated from a non-intumescent material. Similarly, cell 600 shown in FIG. 6 utilizes the same pin design as that of cell 400, except for the inclusion of outer material layer 501. Material layer 501 prevents undesired chemical reactions from occurring between intumescent layer 305 and the materials comprising electrode assembly 103 and the electrolyte contained therein. Material layer 501 may be deposited over intumescent layer 305. Alternately, layer 501 may be in the form of a sleeve, with intumescent material 305 interposed between the inner wall of the sleeve and the outer wall of pin member 203 (or pin member 403). Preferably layer 501 is comprised of a metal that is chemically resistant to the materials used within the battery. Alternately, layer 501 may be comprised of a non-metallic material, such as a plastic, ceramic, or other material.

Throughout the specification, the invention is primarily described relative to cells using the 18650 form-factor. It should be understood, however, that the invention is equally applicable to other form-factors, as well as cells that utilize different designs, shapes, chemistries, cap assemblies, etc., but which include a center pin. For example, the invention may be used with a prismatic cell, in which case the center pin, also referred to as a mandrel, utilizes a square or rectangular shape.

As will be understood by those familiar with the art, the present invention may be embodied in other specific forms without departing from the spirit or essential characteristics thereof. Accordingly, the disclosures and descriptions herein are intended to be illustrative, but not limiting, of the scope of the invention which is set forth in the following claims.

What is claimed is:

1. A battery assembly, comprising:
a cell case;
an electrode assembly contained within said cell case; and
a center pin within said electrode assembly, wherein said electrode assembly is wrapped around said center pin, and wherein said center pin is comprised of an intumescent material.

2. The battery assembly of claim 1, wherein said intumescent material is selected from the group of intumescent materials consisting of graphite-based intumescent materials, thermoplastic elastomers, ceramic-based intumescent materials, vermiculite/mineral fiber based intumescent materials, and ammonium polyphosphate based intumescent materials.

3. The battery assembly of claim 1, wherein said intumescent material has an activation temperature in the range of 75° C. to 150° C.

4. The battery assembly of claim 1, wherein said intumescent material has an activation temperature in the range of 100° C. to 200° C.

5. The battery assembly of claim 1, wherein said intumescent material has an activation temperature in the range of 200° C. to 300° C.

6. The battery assembly of claim 1, wherein said intumescent material has an activation temperature, and wherein said intumescent material exhibits a volume expansion of less than 20× after reaching said activation temperature.

7. The battery assembly of claim 1, wherein said intumescent material has an activation temperature, and wherein said intumescent material exhibits a volume expansion of less than 10× after reaching said activation temperature.

8. The battery assembly of claim 1, wherein said intumescent material has an activation temperature, and wherein said intumescent material exhibits a volume expansion of less than 5× after reaching said activation temperature.

9. The battery assembly of claim 1, wherein said intumescent material has an activation temperature, and wherein said intumescent material exhibits a volume expansion of less than 2× after reaching said activation temperature.

10. The battery assembly of claim 1, said center pin further comprising a hollow member, wherein said intumescent material fills a central void of said hollow member.

11. The battery assembly of claim 10, wherein said hollow member is cylindrically shaped.

12. The battery assembly of claim 10, wherein said hollow member is fabricated from a material selected from the group of materials consisting of metals, plastics, and ceramics.

13. The battery assembly of claim 1, said center pin further comprising a central member, wherein said intumescent material forms a layer surrounding an outer surface of said central member.

14. The battery assembly of claim 13, wherein said central member is solid.

15. The battery assembly of claim 13, wherein said central member is hollow.

16. The battery assembly of claim 13, wherein said central member is cylindrically shaped.

17. The battery assembly of claim 13, wherein said central member is fabricated from a material selected from the group of materials consisting of metals, plastics, and ceramics.

18. The battery assembly of claim 13, said center pin further comprising a layer of a non-intumescent material surrounding said layer of intumescent material surrounding said outer surface of said central member.

19. The battery assembly of claim 18, wherein said layer of said non-intumescent material is selected from the group of materials consisting of metals, plastics, and ceramics.

20. The battery assembly of claim 18, wherein said layer of said non-intumescent material is in the form of a sleeve.
